(19) United States
(12) Patent Application Publication
(10) Pub. No.: US 2010/0199922 A1
(43) Pub. Date: Aug. 12, 2010

(54) BALL CARRYING DEVICE

(76) Inventor: THERESA GUERRERO, San Francisco, CA (US)

Correspondence Address: James Ray & Associates, 2640 Pitcairn Road, Monroeville, PA, 15146, US

(21) Appl. No.: 12/367,731

(22) Filed: Feb. 9, 2009

(51) Int. Cl. A01K 29/00; A45F 5/00

(52) U.S. Cl. 119/707; 224/600

(57) ABSTRACT

An apparatus for carrying a ball having a first predetermined size used in playing with an animal includes a housing for such ball, such housing has an opening disposed at a first end thereof and is manufactured from a predetermined material and has a second predetermined size and a predetermined shape and. A drawstring member has a first end and a second end, such first end being threaded through such housing closely adjacent such opening such that such first end may be selectively tightened and loosened such that such opening may be maintained in an open position, a closed position, and a combination thereof. A securing mechanism is disposed on such second end of such drawstring member for releasably securing such second end of such drawstring member to at least one of a predetermined object, a predetermined portion of a predetermined article of clothing, and a combination thereof.

### FIELD OF THE INVENTION

The present invention relates, in general, to ball carrying devices and, more particularly, this invention relates to a device for use in aiding a user in carrying a ball and housing such ball to limit a user's contact with such ball after such ball has been played with by an animal.

### BACKGROUND OF THE INVENTION

Prior to the conception and development of the present invention, it has generally been well known in the prior art to provide a ball for use in throwing for a pet to fetch. Unfortunately once such ball has been thrown and retrieved a number of times, and sometimes even just once, such ball becomes dirty, soaked with saliva, covered with debris, and repulsive. Carrying such ball can be unpleasant and can result in soiling of a user's clothing. Furthermore, if a user is carrying such ball after use and if the pet can still see the ball the pet may continue to behave in an excited manner making it difficult to restrain such pet and direct it on to the next activity or location.

### SUMMARY OF THE INVENTION

An apparatus for carrying a ball having a first predetermined size used for playing with an animal is provided. Such apparatus includes a housing for housing such ball. Such housing is manufactured from a predetermined material and has a second predetermined size and a predetermined shape. Such housing includes an opening disposed at a first end thereof. A drawstring member has a first end and a second end, such first end of such drawstring member is threaded through such housing closely adjacent such opening such that such first end of such drawstring member may be selectively tightened and loosened by a user such that such opening may be maintained in at least one of an open position, a closed position, and a combination thereof. A securing means is disposed on such second end of such drawstring member for releasably securing such second end of such drawstring member to at least one of a predetermined object, a predetermined portion of a predetermined article of clothing, and a combination thereof.

According to another embodiment, in combination with a ball throwing device having an elongated rod member equipped with a first end and a second end and wherein such first end of such elongated rod member is formed as a scoop member for scooping a ball having a first predetermined size an improvement is provided which includes a housing for housing such ball, such housing being manufactured from a predetermined material and having a second predetermined size and a predetermined shape, such housing including an opening disposed at a first end thereof. A drawstring member has a first end and a second end, such first end of such drawstring member is threaded through such housing closely adjacent such opening such that such first end of such drawstring member may be selectively tightened and loosened by a user such that such opening may be maintained in at least one of an open position, a closed position, and a combination thereof. A securing means is disposed on such second end of such drawstring member for releasably securing such second end of such drawstring member to such second end of such elongated rod member.

### OBJECTS OF THE INVENTION

It is, therefore, one of the primary objects of the present invention to provide an apparatus for covering and carrying a ball after a pet has played with such ball, thereby enabling a user to have limited contact with such ball thereby minimizing such user's contact with dirt, germs, debris, and saliva which have accumulated on such ball.

Another object of the present invention is to provide a device for housing a ball and for transporting such ball to and from a play area.

Still another object of the present invention is to provide a housing which is attachable to a ball throwing device having an elongated rod member including a scoop type member disposed at a first end thereof for scooping a ball of a first predetermined size and moving such ball in a predetermined direction; such housing for such ball including a drawstring type member having a first end thereof disposed there through such housing closely adjacent an open end thereof, such drawstring type member being for use in drawing such open end closed, a second end of such drawstring member being elongated and including a securing means disposed thereon for securing such second end of such drawstring member to a second end of such rod member.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3a is a partial perspective view of the invention according to one embodiment of the invention in which the device is slung over the shoulder of a user.

FIG. 3b is a partial perspective view of the invention according to one embodiment of the invention in which the device is slung over the shoulder of a user.

FIG. 4 is a partial perspective view of the invention according to one embodiment of the invention in which the invention has been secured to a ball throwing device.

FIG. 5 is a partial perspective view of the invention according to one embodiment of the invention in which the invention has been secured to a ball throwing device via a clasp and via enclosing a scoop member disposed on an end of such ball throwing device within such housing and thereafter tightening such drawstring member.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

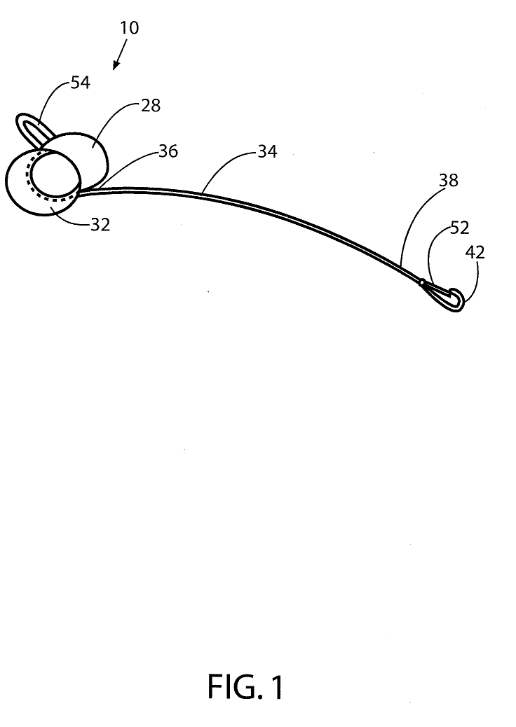

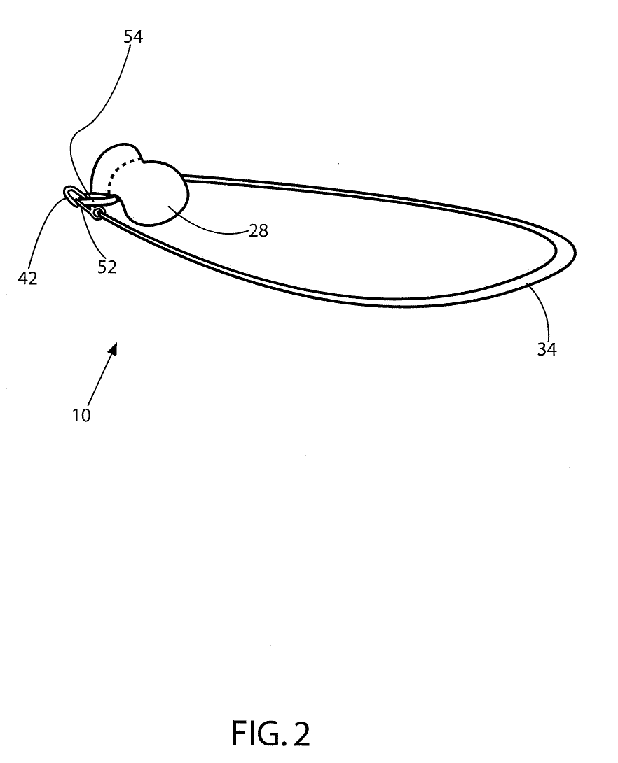

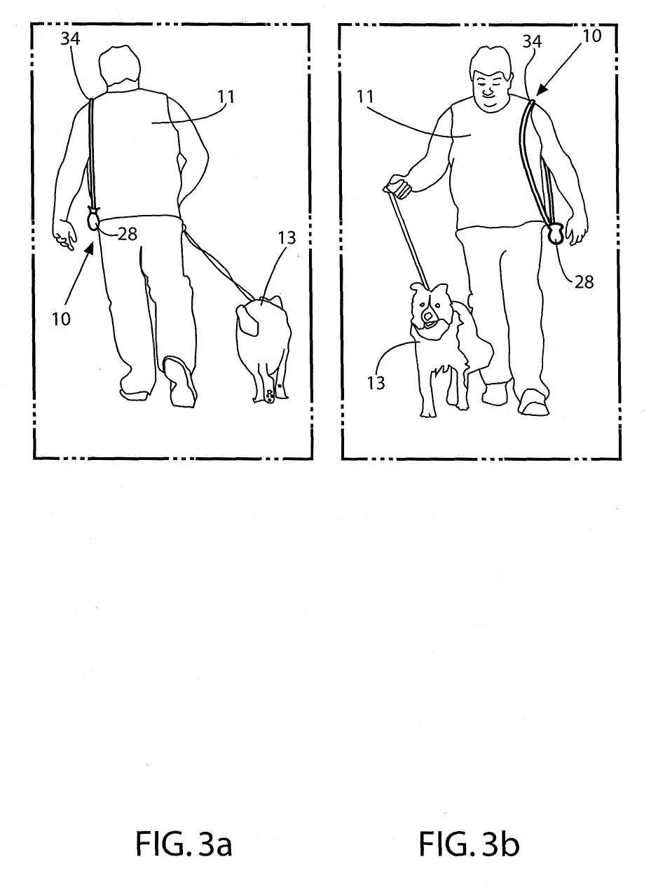

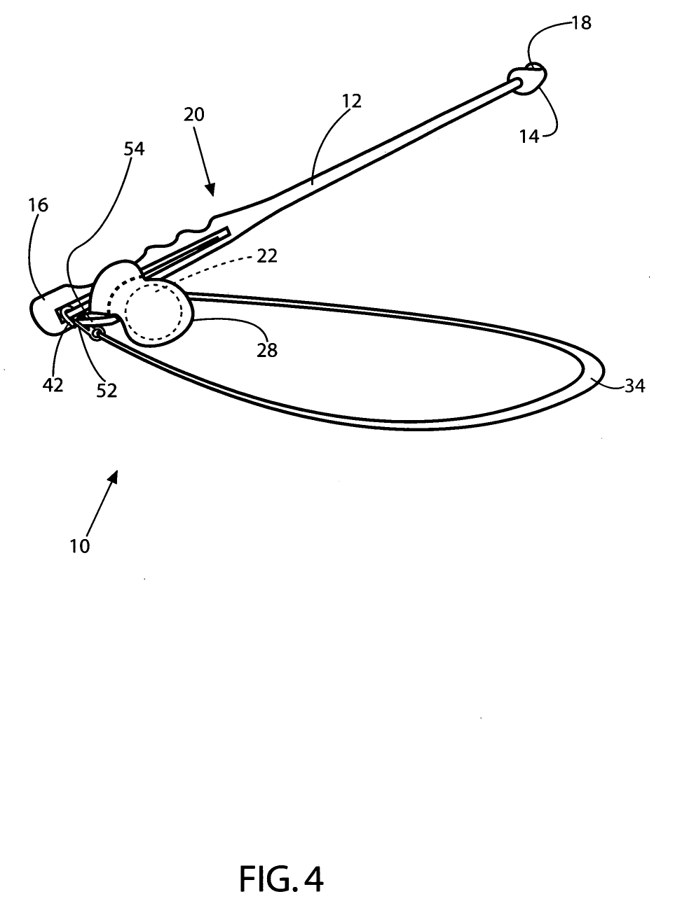

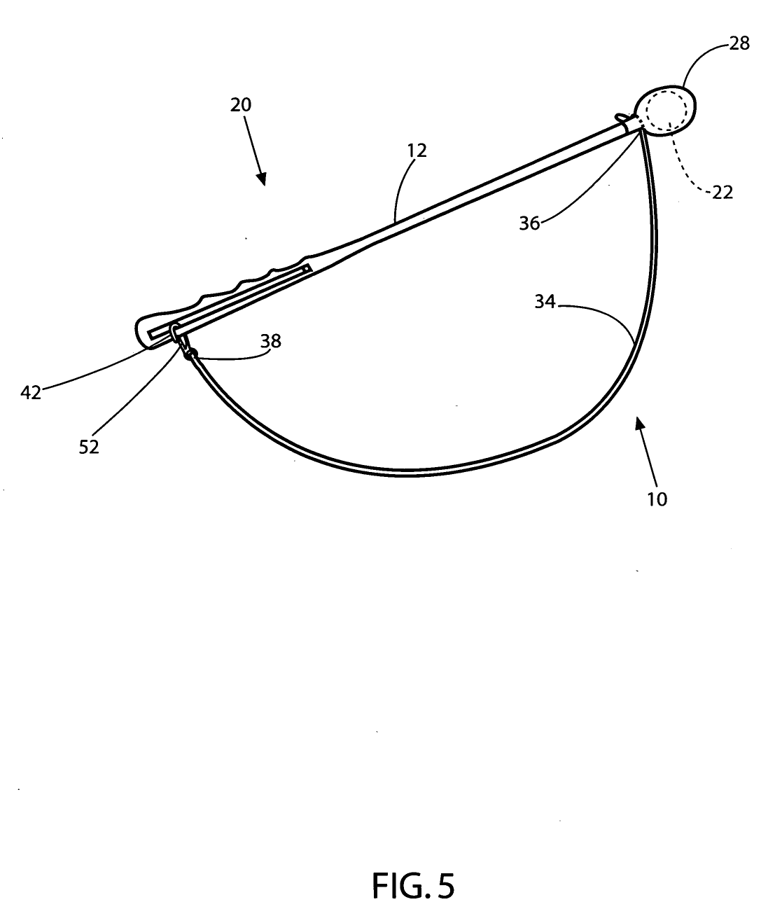

Reference is now made, more particularly, to FIGS. 1-5.

An apparatus for carrying a ball having a predetermined size used in playing with an animal 13 is provided.

Such apparatus, generally designated 10, includes a housing 28 for housing such ball 22. Such housing 28 includes an opening disposed at a first end 32 thereof. Such housing 28 is manufactured from a predetermined material and has a second predetermined size and a predetermined shape. It is presently preferred that such predetermined material is at least one of fabric, plastic, cellulose, and a combination thereof. According to one embodiment such predetermined material is disposable.

A drawstring member 34 has a first end 36 and a second end 38, such first end 36 of such drawstring member 34 is threaded through such housing 28 closely adjacent such opening such that such first end 36 of such drawstring member 34 may be selectively tightened and loosened by a user 11 such that such opening may be maintained in at least one of an open position, a closed position, and a combination thereof. It is presently preferred that such drawstring member 34 is nylon.

A securing means 42 is disposed on such second end 38 of such drawstring member 34 for releasably securing such second end 38 of such drawstring member 34 to at least one of a predetermined object, a predetermined portion of a predetermined article of clothing, and a combination thereof.

It is presently preferred that such securing means 42 includes a clasp member 52 disposed on such second end 38 of such drawstring member 34.

It is presently preferred that such housing 28 further includes a loop member 54 disposed thereon for being releasably clasped by such clasp member 52 such that such user 11 may carry such apparatus 10 over at least one of such user's shoulder and such user's arm by encircling such at least one of such user's shoulder and such user's arm with such drawstring member 34 when such clasp is clasped to such loop member 54.

According to one embodiment, such predetermined portion of such predetermined article of clothing is a belt loop (not shown).

According to another embodiment, such predetermined object is a ball throwing device, generally designated 20, having an elongated rod member 12 equipped with a first end 14 and a second end 16, such first end 14 of such elongated rod member 12 formed as a scoop member 18 for scooping such ball 22 having such first predetermined size, such second end 16 of such elongated rod member 12 having an aperture disposed there through for being clasped by such clasp member 52.

According to another embodiment, in combination with a ball throwing device, generally designated 20, having an elongated rod member 12 equipped with a first end 14 and a second end 16, such first end 14 of such elongated rod member 12 formed as a scoop member 18 for scooping a ball 22 having a first predetermined size, an improvement is provided which includes a housing 28 for housing such ball 22, such housing 28 being manufactured from a predetermined material and having a second predetermined size and a predetermined shape, such housing 28 including an opening disposed at a first end thereof.

A drawstring member 34 has a first end 36 and a second end 38, such first end 36 of such drawstring member 34 is threaded through such housing 28 closely adjacent such opening such that such first end 36 of such drawstring member 34 may be selectively tightened and loosened by a user 11 such that such opening may be maintained in at least one of an open position, a closed position, and a combination thereof. It is presently preferred that such drawstring member 34 is nylon.

A securing means 42 is disposed on such second end 38 of such drawstring member 34 for releasably securing such second end 38 of such drawstring member 34 to such second end of such elongated rod member.

It is presently preferred that such securing means 42 includes a clasp member 52 disposed on such second end 38 of such drawstring member 34, such clasp member 52 being claspable to an aperture disposed through such second end 16 of such elongated rod member 12 closely adjacent an edge thereof.

It is presently preferred that such housing 28 further includes a loop member 54 disposed thereon for being releasably clasped by such clasp member 52 such that such housing 28 may be secured closely adjacent to such second end 16 of such elongated rod member 12 when such clasp member 52 is clasped to such aperture disposed through such second end 16 of such elongated rod member 12.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

1. An apparatus for carrying a ball having a first predetermined size used in playing with an animal, said apparatus comprising:
a. a housing for housing such ball, said housing being manufactured from a predetermined material and having a second predetermined size and a predetermined shape, said housing including an opening disposed at a first end thereof;
b. a drawstring member having a first end and a second end, said first end of said drawstring member being threaded through said housing closely adjacent said opening such that said first end of such drawstring member may be selectively tightened and loosened by a user such that said opening may be maintained in at least one of an open position, a closed position, and a combination thereof; and
d. a securing means disposed on said second end of said drawstring member for releasably securing said second end of said drawstring member to at least one of a predetermined object, a predetermined portion of a predetermined article of clothing, and a combination thereof.

2. The apparatus according to claim 1 wherein said predetermined material is at least one of fabric, plastic, cellulose, and a combination thereof.

3. The apparatus according to claim 1 wherein said predetermined material is disposable.

4. The apparatus according to claim 1 wherein said drawstring member is nylon.

5. The apparatus according to claim 1 wherein said securing means includes a clasp member disposed on said second end of said drawstring member.

6. The apparatus according to claim 5 wherein said housing further includes a loop member disposed thereon for being releasably clasped by said clasp member such that a user may carry such apparatus over at least one of such user's shoulder and such user's arm by encircling such at least one of such user's shoulder and such user's arm with such drawstring member clasped to such loop member.

7. The apparatus according to claim 1 wherein said predetermined portion of such predetermined article of clothing is a belt loop.

8. The apparatus according to claim 1 wherein said predetermined object is a ball throwing device having an elongated rod member equipped with a first end and a second end, said first end of said elongated rod member formed as a scoop member for scooping a ball having a first predetermined size, said first end of said elongated rod member having an aperture disposed there through for being clasped by said clasp member.

9. In combination with a ball throwing device having an elongated rod member equipped with a first end and a second end, said first end of said elongated rod member formed as a scoop member for scooping a ball having a first predetermined size, the improvement comprising;
a. a housing for housing such ball, said housing being manufactured from a predetermined material and having a second predetermined size and a predetermined shape, said housing including an opening disposed at a first end thereof;
b. a drawstring member having a first end and a second end, said first end of said drawstring member being threaded through said housing closely adjacent said opening such that said first end of such drawstring member may be selectively tightened and loosened by a user such that said opening may be maintained in at least one of an open position, a closed position, and a combination thereof; and
d. a securing means disposed on at least one of such second end of said drawstring member for releasably securing said second end of said drawstring member to said second end of said elongated rod member.

10. The apparatus according to claim 9 wherein said predetermined material is at least one of fabric, plastic, cellulose, and a combination thereof.

11. The apparatus according to claim 9 wherein said predetermined material is disposable.

12. The apparatus according to claim 9 wherein said drawstring member is nylon.

13. The apparatus according to claim 9 wherein said securing means includes a clasp member disposed on said second end of said drawstring member, said clasp member being claspable to an aperture disposed through said second end of said elongated rod member closely adjacent an edge thereof.

14. The apparatus according to claim 13 wherein said housing further includes a loop member disposed thereon for being releasably clasped by said clasp member such that said housing may be secured closely adjacent to said second end of said elongated rod member when said clasp member is clasped to said aperture disposed through said second end of said elongated rod member.
